(19) United States
(12) Patent Application Publication
(10) Pub. No.: US 2023/0228270 A1
(43) Pub. Date: Jul. 20, 2023

(54) ROTARY COMPRESSOR

(71) Applicant: LG ELECTRONICS INC., Seoul (KR)

(72) Inventors: Seseok SEOL, Seoul (KR); Jinung SHIN, Seoul (KR); Sedong LEE, Seoul (KR)

(21) Appl. No.: 17/989,873

(22) Filed: Nov. 18, 2022

(30) Foreign Application Priority Data
Jan. 14, 2022 (KR) 10-2022-0006068

(51) Int. Cl. F04C 29/00; F04C 18/344

(52) U.S. Cl. CPC F04C 29/0078; F04C 18/344

(57) ABSTRACT

A rotary compressor is provided that may include a rotation preventing key between a roller and a rotary shaft, the roller being a separable-type roller assembled into the rotary shaft. The rotation preventing unit may constrain rotation of the roller and allow axial movement of the roller with respect to the rotary shaft. Thus, axial movement of the roller along the rotary shaft may be suppressed or prevented, and thus, friction loss and abrasion between the roller and a main bearing or between the roller or a sub bearing may be suppressed or prevented.

### CROSS-REFERENCE TO RELATED APPLICATION(S)

Pursuant to 35 U.S.C. § 119(a), this application claims the benefit of the earlier filing date and the right of priority to Korean Patent Application No. 10-2022-0006068, filed in Korea on Jan. 14, 2022, the contents of which are incorporated by reference herein in their entirety.

### BACKGROUND

### 1. Field

A rotary compressor in which a rotary shaft is assembled with a roller is disclosed herein.

### 2. Background

A rotary compressor is classified into a rotary compressor type in which a vane is slidably inserted into a cylinder to be in contact with a roller, and a rotary compressor type in which a vane is slidably inserted into a roller to be in contact with a cylinder. In general, the former is called a rotary compressor with an eccentric roller (hereinafter, referred to as a “rotary compressor”), and the latter is called a concentric vane rotary compressor (hereinafter, referred to as a “vane rotary compressor”).

As for a rotary compressor, a vane inserted in a cylinder is pulled out toward a roller by elastic force or back pressure to come into contact with an outer circumferential surface of the roller. On the other hand, for a vane rotary compressor, a vane inserted in a roller rotates together with the roller, and is pulled out by centrifugal force and back pressure to come into contact with an inner circumferential surface of a cylinder.

A rotary compressor independently forms as many compression chambers as the number of vanes per revolution of a roller, and the compression chambers simultaneously perform suction, compression, and discharge strokes. On the other hand, a vane rotary compressor continuously forms as many compression chambers as the number of vanes per revolution of a roller, and the compression chambers sequentially perform suction, compression, and discharge strokes. Therefore, the vane rotary compressor provides a higher compression ratio than the rotary compressor. Thus, the vane rotary compressor is more suitable for high pressure refrigerants, such as R32, R410a, and CO₂, which have low ozone depletion potential (ODP) and global warming index (GWP).

The vane rotary compressor is generally configured such that a center of the roller matches a center of the rotary shaft. Thus, the vane rotary compressor may be referred to as a concentric vane-type rotary compressor. Hereinafter, the concentric vane-type rotary compressor is defined as a vane rotary compressor in the description.

The vane rotary compressor is disclosed in Japanese Patent Publication No. JP 2013-072429A (hereinafter “Patent Document 1”) and Japanese Patent Publication No. JP 2013-050038A (hereinafter “Patent Document 2”), which are hereby incorporated by reference. The vane rotary compressor in Patent Document 1 discloses an example in which a roller is manufactured integrally with a rotary shaft. Patent Document 2 discloses an example in which a roller and a rotary shaft are separately manufactured, and then, post-assembled with each other. In this case, an outer circumferential surface of the rotary shaft and an inner circumferential surface of the roller have a circular shape to be press-fit, or machined to have a serration or gear shape to be pressed or press-fit. Alternatively, the roller and the rotary shaft may be coupled to each other using a fixing pin penetrating therethrough.

However, as described above, when the roller is manufactured integrally or post-assembled, the rotary shaft and the roller are provided as a single body. Thus, when magnetic centering such that a rotor is aligned with a center of a stator is performed, the roller axially moves with the rotary shaft coupled to the rotor. Then, as one axial side surface of the roller, for example, an upper bearing surface, is brought into close contact with a thrust surface of a main bearing facing the upper bearing surface, friction loss or abrasion occurs. In addition, as a gap between the roller and a sub bearing is enlarged in correspondence with raising of the roller, leakage between compression chambers occurs, thereby deteriorating compression efficiency.

In addition, when the rotary shaft and the roller are manufactured as a single body as described above, the rotary shaft and the roller are manufactured using a same material. When the rotary shaft and the roller are separately machined and post-assembled as a single body, the rotary shaft and the roller are also manufactured using a same material or materials having similar rigidity and hardness in consideration of coupling reliability. Thus, as there are limits in selecting a material of the roller and reducing a weight of the roller, motor efficiency may not be increased.

In addition, as described above, when the rotary shaft and the roller are post-assembled as a single body, as a change in a post-assembly process may occur, the rotary shaft and the roller are assembled, and then, post-machined. In other words, primary processing of separately machining the rotary shaft and the roller is performed, then, the rotary shaft and the roller on which the primary machining is performed are post-assembled, and then, secondary machining of grinding a vane slot and a cross section and an outer circumferential surface with respect to the roller is performed. Thus, as machining time increases, manufacture costs may increase.

### BRIEF DESCRIPTION OF THE DRAWINGS

Embodiments will be described in detail with reference to the following drawings in which like reference numerals refer to like elements, and wherein:

FIG. 1 is a cross-sectional view of a vane rotary compressor according to an embodiment;

FIG. 2 is an exploded perspective view illustrating a compression unit of FIG. 1;

FIG. 3 is an assembled planar view of the compression unit in FIG. 2;

FIG. 4 is an exploded perspective view of a rotary shaft and a roller in FIG. 2;

FIG. 5 is an assembled perspective view of the rotary shaft and the roller in FIG. 4;

FIG. 6 is a cross-sectional view of FIG. 5;

FIG. 7 is an enlarged sectional view of a rotation preventing unit of FIG. 6;

FIG. 8A is a cross-sectional view illustrating a relation between the rotary shaft and the roller in a stop state of the compressor;

FIG. 8B is a cross-sectional view illustrating a relation between the rotary shaft and the roller in an operation state of the compressor;

FIG. 9 is an exploded perspective view of a rotation preventing key of FIG. 1 according to another embodiment;

FIG. 10 is an assembled cross-sectional view of FIG. 9;

FIG. 11 is an exploded perspective view of the roller of FIG. 1 according to another embodiment;

FIG. 12 is a planar view of an assembled state of a rotation preventing unit of FIG. 11;

FIG. 13 is a fractured perspective view of a rotation preventing groove of FIG. 1 according to another embodiment;

FIG. 14A is a cross-sectional view illustrating a relation between the rotary shaft and the roller in a stopped state of a compressor of FIG. 13;

FIG. 14B is a cross-sectional view illustrating a relation between the rotary shaft and the roller in an operation state of the compressor of FIG. 13;

FIG. 15 is a perspective view of the rotation preventing key of FIG. 1 according to another embodiment; and

FIG. 16 is a planar view of FIG. 15.

### DETAILED DESCRIPTION

Description will now be given of a vane rotary compressor according to embodiments disclosed herein, with reference to the accompanying drawings. Embodiments provide a roller assembled with a rotary shaft and coupled thereto to be movable in an axial direction within a certain or predetermined range. This may apply to not only a vane rotary compressor in which a vane is slidably inserted into a roller, but also a general rotary compressor in which a vane is slidably inserted into a cylinder. Hereinafter, a vane rotary compressor is described as a representative example.

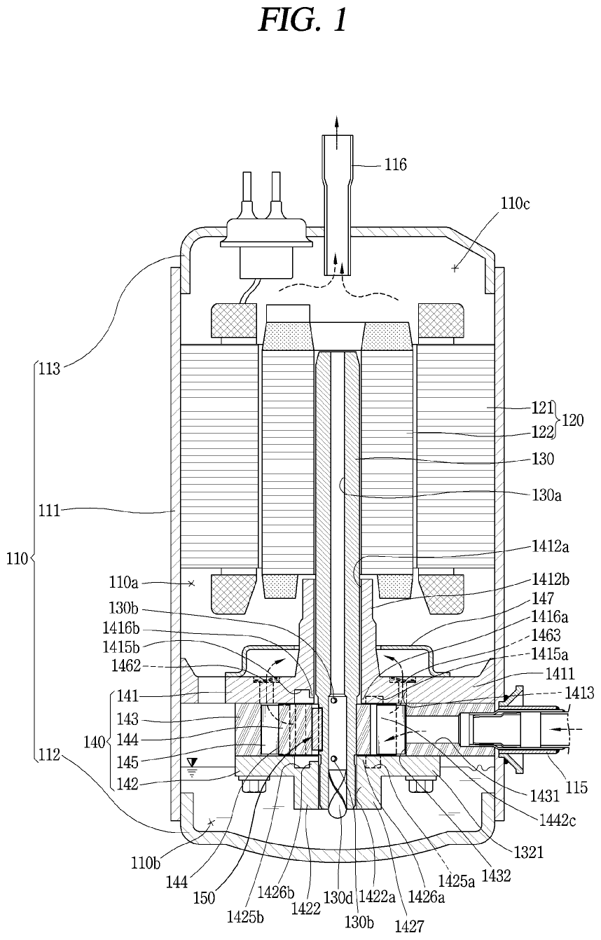

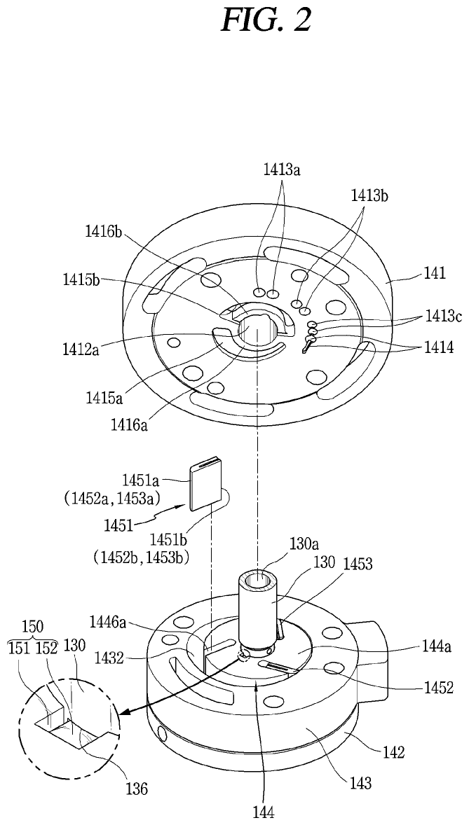

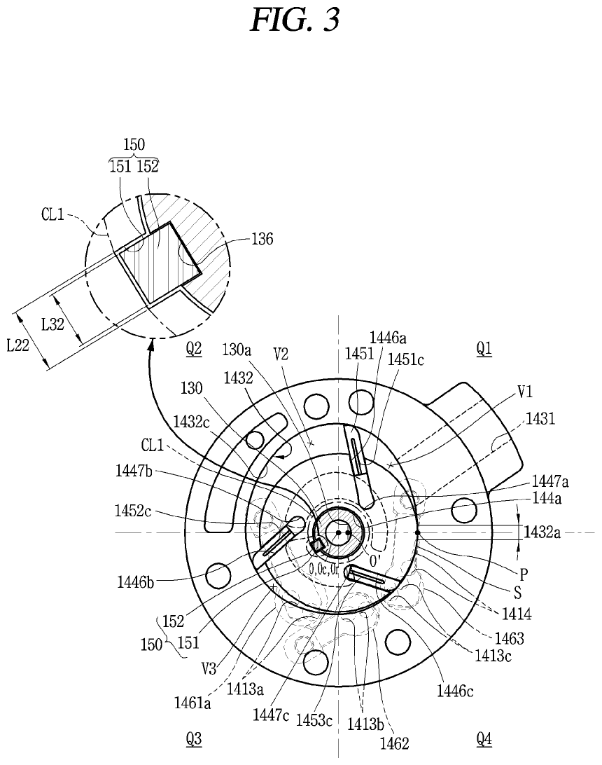

FIG. 1 is a cross-sectional view of a vane rotary compressor according to an embodiment. FIG. 2 is an exploded perspective view illustrating a compression unit of FIG. 1. FIG. 3 is an assembled planar view of the compression unit in FIG. 2.

Referring to FIG. 1, a vane rotary compressor according to this embodiment may include a casing 110, a or drive motor 120, a rotary shaft 130, and a compression unit 140. The drive motor 120 may be installed in an upper inner space 110a of the casing 110, and the compression unit 140 may be installed in a lower inner space 110a of the casing 110. The drive motor 120 and the compression unit 140 are connected through the rotary shaft 130.

The casing 110 that defines an outer appearance of the compressor may be classified as a vertical type and a horizontal type according to a compressor installation method. As for the vertical type casing, the drive motor 120 and the compression unit 140 are disposed at upper and lower sides in an axial direction, respectively. As for the horizontal type casing, the drive motor 120 and the compression unit 140 are disposed at left and right sides or lateral, respectively. The casing according to this embodiment may be illustrated as the vertical type.

The casing 110 may include an intermediate shell 111 having a cylindrical shape, a lower shell 112 that covers a lower end of the intermediate shell 111, and an upper shell 113 that covers an upper end of the intermediate shell 111. The drive motor 120 and the compression unit 140 may be inserted into the intermediate shell 111 to be fixed thereto, and a suction pipe 115 may penetrate through the intermediate shell 111 to be directly connected to the compression unit 140. The lower shell 112 may be coupled to the lower end of the intermediate shell 111 in a sealing manner, and an oil storage space 110b in which oil to be supplied to the compression unit 140 is stored may be formed below the compression unit 140. The upper shell 113 may be coupled to the upper end of the intermediate shell 111 in a sealing manner, and an oil separation space 110c may be formed above the drive motor 120 to separate oil from refrigerant discharged from the compression unit 140.

The drive motor 120 which constitutes a motor unit supplies power to cause the compression unit 140 to be driven. The drive motor 120 may include a stator 121 and a rotor 122.

The stator 121 may be fixedly inserted into the casing 110. The stator 121 may be fixed to an inner circumferential surface of the casing 110 in a shrink-fitting manner, for example. For example, the stator 121 may be press-fitted into an inner circumferential surface of the intermediate shell 111.

The rotor 122 may be rotatably inserted into the stator 121, and the rotary shaft 130 may be press-fitted into a center of the rotor 122. Accordingly, the rotary shaft 130 rotates concentrically together with the rotor 122.

An oil flow path 130a having a hollow hole shape may be provided in a central portion of the rotary shaft 130, and oil passage holes 130b and 130c may be provided through a middle portion of the oil flow path 130a toward an outer circumferential surface of the rotary shaft 130. The oil passage holes 130b and 130c may include first oil passage hole 130b belonging to a range of a main bush portion 1412 described hereinafter and a second oil passage hole 130c belonging to a range of a sub bush portion 1422. Each of the first oil passage hole 130b and the second oil passage hole 130c may be provided as one or as a plurality. In this embodiment, the first and second oil passage holes are respectively provided as a plurality.

An oil pickup 130d may be installed in or at a middle portion or a lower end of the oil flow path 130a. A gear pump, a viscous pump, or a centrifugal pump, for example, may be used for the oil pickup 130d. In this embodiment, a case in which a centrifugal pump is employed is illustrated. Accordingly, when the rotary shaft 130 rotates, oil filled in the oil storage space 110b is pumped by the oil pickup 130d and is suctioned along the oil flow path 130a to be supplied into a sub bearing surface (no reference numeral) of the sub bush portion 1422 through the second oil passage hole 130c and into a main bearing surface (no reference numeral) of the main bush portion 1412 through the first oil passage hole 130b.

The rotary shaft 130 may include a roller 144 described hereinafter. The roller 144 may extend integrally from the rotary shaft 130. Alternatively, the rotary shaft 130 and the roller 144 may be separately manufactured, and then, post-assembled with each other. In this embodiment, the rotary shaft 130 is inserted into the roller 144, and then, post-assembled. For example, a shaft hole 1441 may penetrate through a center of the roller 144 in the axial direction and the rotary shaft 130 may be inserted and coupled into the shaft hole 1441.

A rotation preventing key 152 may be provided on an outer circumferential surface of the rotary shaft 130, and a rotation preventing groove 151 may be provided in an inner circumferential surface of the roller 144, that is, an inner circumferential surface of the shaft hole 1441. The rotation preventing key 152 may protrude in a radial direction, and the rotation preventing groove 151 may be recessed in the radial direction so that the rotation preventing key 152 is inserted therein. Accordingly, the rotary shaft 130 and the roller 144 may be mutually constrained in the circumferential direction.

As illustrated in FIG. 3, the rotation preventing key 152 and rotation preventing groove 151 may be provided between vane slots 1446a, 1446b, and 1446c described hereinafter, that is, between two vane slots neighboring in the circumferential direction. In this case, key accommodating rotation preventing unit 150 including the rotation preventing key 152 and the rotation preventing groove 151 may be located in a middle position between the two vane slots. Accordingly, a circumferential side surface of the rotation preventing groove 151 may be prevented from being damaged by a circumferential force delivered through the rotation preventing groove 151.

In addition, the rotation preventing key 152 and the rotation preventing groove 151 may be provided in or at positions that do not overlap the vane slots 1446a, 1446b, and 1446c in the circumferential direction. In other words, a virtual circle CL1 connecting an outer side surface of the rotation preventing groove 151 may be provided in a further inner position compared to the vane slots (back pressure chambers) 1446a, 1446b, and 1446c in the radial direction. Accordingly, by reducing a length by which the rotation prevention key 152 radially protrudes, a coupling reliability with respect to the rotation preventing key 152 may be enhanced.

Only one rotation preventing key 152 and one rotation preventing groove 151 may be provided as illustrated in the drawings; however, in some cases, a plurality of rotation preventing keys 152 and a plurality of rotation preventing grooves 151 may be provided at equal intervals along the circumferential direction. A coupling relationship between the rotary shaft 130 and the roller 144 will be described hereinafter together with the roller 144.

The compression unit 140 may include a main bearing 141, a sub bearing 142, a cylinder 143, roller 144, and a plurality of vanes 1451, 1452, and 1453. The main bearing 141 and the sub bearing 142 may be respectively provided at upper and lower parts or portions of the cylinder 143 to define a compression space V together with the cylinder 143, the roller 144 may be rotatably installed in the compression space V, and the vanes 1451, 1452, and 1453 may be slidably inserted into the roller 144 to divide the compression space V into a plurality of compression chambers.

Referring to FIGS. 1 to 3, the main bearing 141 may be fixedly installed in the intermediate shell 111 of the casing 110. For example, the main bearing 141 may be inserted into the intermediate shell 111 and welded thereto.

The main bearing 141 may be coupled to an upper end of the cylinder 143 in a close contact manner. Accordingly, the main bearing 141 defines an upper surface of the compression space V, and supports an upper surface of the roller 144 in the axial direction, and at the same time, supports an upper portion of the rotary shaft 130 in the radial direction.

The main bearing 141 may include a main plate portion 1411 and a main bush portion 1412. The main plate portion 1411 covers an upper part or portion of the cylinder 143 to be coupled thereto, and the main bush portion 1412 axially extends from a center of the main plate portion 1411 toward the drive motor 120 so as to support the upper portion of the rotary shaft 130.

The main plate portion 1411 may have a disk shape, and an outer circumferential surface of the main plate portion 1411 may be fixed to the inner circumferential surface of the intermediate shell 111 in a close contact manner. One or more discharge ports 1413a, 1413b, and 1413c may be formed in the main plate portion 1411, and a plurality of discharge valves 1461, 1462, and 1463 configured to open and close the respective discharge ports 1413a, 1413b, and 1413c may be installed on an upper surface of the main plate portion 1411. A discharge muffler 147 having a discharge space (no reference numeral) may be provided at an upper part or portion of the main plate portion 1411 to accommodate the discharge ports 1413a, 1413b, and 1413c, and the discharge valves 1461, 1462, and 1463.

A first main back pressure pocket 1415a and a second main back pressure pocket 1415b may be formed in a lower surface, namely, a main sliding surface 1411a of the main plate portion 1411 facing the upper surface of the roller 144, of both axial side surfaces of the main plate portion 1411. The first main back pressure pocket 1415a and the second main back pressure pocket 1415b each having an arcuate shape may be disposed at a predetermined interval in the circumferential direction. Each of the first main back pressure pocket 1415a and the second main back pressure pocket 1415b may have an inner circumferential surface with a circular shape, but may have an outer circumferential surface with an oval or elliptical shape in consideration of vane slots described hereinafter.

The first main back pressure pocket 1415a and the second main back pressure pocket 1415b may be formed within an outer diameter range of the roller 144. Accordingly, the first main back pressure pocket 1415a and the second main back pressure pocket 1415b may be separated from the compression space V. However, the first main back pressure pocket 1415a and the second main back pressure pocket 1415b may slightly communicate with each other through a gap between a lower surface, a main sliding surface 1411a of the main plate portion 1411 and the upper surface of the roller 144 facing each other unless a separate sealing member is provided therebetween.

The first main back pressure pocket 1415a forms a pressure lower than a pressure formed in the second main back pressure pocket 1415b, for example, forms an intermediate pressure between a suction pressure and a discharge pressure. Oil (refrigerant oil) may pass through a fine passage between a first main bearing protrusion 1416a described hereinafter and the upper surface of the roller 144 so as to be introduced into the first main back pressure pocket 1415a. The first main back pressure pocket 1415a may be formed in the range of a compression chamber forming intermediate pressure in the compression space V. This may allow the first main back pressure pocket 1415a to maintain the intermediate pressure.

The second main back pressure pocket 1415b may form a pressure higher than that in the first main back pressure pocket 1415a, for example, the discharge pressure or intermediate pressure between the suction pressure close to the discharge pressure and the discharge pressure. Oil flowing into the main bearing hole 1412a of the main bearing 1412 through the first oil passage hole 130b may be introduced into the second main back pressure pocket 1415b. The second main back pressure pocket 1415b may be formed in the range of a compression chamber forming the discharge pressure in the compression space V. This may allow the second main back pressure pocket 1415b to maintain the discharge pressure.

In addition, a first main bearing protrusion 1416a and a second main bearing protrusion 1416b may be formed on inner circumferential sides of the first main back pressure pocket 1415a and the second main back pressure pocket 1415b, respectively, in a manner of extending from the main bearing surface (no reference numeral) of the main bush potion 1412. Accordingly, the first main back pressure pocket 1415a and the second main back pressure pocket 1415b may be sealed from outside and simultaneously the rotary shaft 130 may be stably supported.

The first main bearing protrusion 1416a and the second main bearing protrusion 1416b may have a same height or different heights. For example, when the first main bearing protrusion 1416a and the second main bearing protrusion 1416b have the same height, an oil communication groove (not illustrated) or an oil communication hole (not illustrated) may be formed on an end surface of the second main bearing protrusion 1416b such that inner and outer circumferential surfaces of the second main bearing protrusion 1416b may communicate with each other. Accordingly, high-pressure oil (refrigerant oil) flowing into the main bearing surface (no reference numeral) may be introduced into the second main back pressure pocket 1415b through the oil communication groove (not illustrated) or the oil communication hole (not illustrated).

On the other hand, when the first main bearing protrusion 1416a and the second main bearing protrusion 1416b have different heights, the height of the second main bearing protrusion 1416b may be lower than the height of the first main bearing protrusion 1416a. Accordingly, high-pressure oil (refrigerant oil) flowing into the main bearing hole 1412a may be introduced into the second main back pressure pocket 1415b by passing over the second main bearing protrusion 1416b.

Referring to FIGS. 1 to 3, the sub bearing 142 may be coupled to a lower end of the cylinder 143 in a close contact manner. Accordingly, the sub bearing 142 defines a lower surface of the compression space V, and supports a lower surface of the roller 144 in the axial direction, and at the same time, supports a lower portion of the rotary shaft 130 in the radial direction.

The sub bearing 142 may include a sub plate portion 1421 and the sub bush portion 1422. The sub plate portion 1421 may cover a lower part or portion of the cylinder 143 to be coupled thereto, and the sub bush portion 1422 may axially extend from a center of the sub plate portion 1421 toward the lower shell 112 so as to support the lower portion of the rotary shaft 130. The sub plate portion 1421 may have a disk shape like the main plate portion 1411, and an outer circumferential surface of the sub plate portion 1421 may be spaced apart from the inner circumferential surface of the intermediate shell 111.

A first sub back pressure pocket 1425a and a second sub back pressure pocket 1425b may be formed on an upper surface, namely, a sub sliding surface 1421a of the sub plate portion 1421 facing the lower surface of the roller 144, of both axial side surfaces of the sub plate portion 1421. The first sub back pressure pocket 1425a and the second sub back pressure pocket 1425b may be symmetric to the first main back pressure pocket 1415a and the second main back pressure pocket 1415b, respectively, with respect to the roller 144.

For example, the first sub back pressure pocket 1425a and the first main back pressure pocket 1415a may be symmetric to each other, and the second sub back pressure pocket 1425b and the second main back pressure pocket 1415b may be symmetric to each other. Accordingly, a first sub bearing protrusion 1426a may be formed on an inner circumferential side of the first sub back pressure pocket 1425a, and a second sub bearing protrusion 1426b may be formed on an inner circumferential side of the second sub back pressure pocket 1425b.

Descriptions of the first sub back pressure pocket 1425a and the second sub back pressure pocket 1425b, and the first sub bearing protrusion 1426a and the second sub bearing protrusion 1426b may be the same as or replaced by descriptions of the first main back pressure pocket 1415a and the second main back pressure pocket 1416b, and the first main bearing protrusion 1416a and the second main bearing protrusion 1316b. Thus, repetitive description has been omitted.

However, in some cases, the first sub back pressure pocket 1425a and the second sub back pressure pocket 1425b may be asymmetric to the first main back pressure pocket 1415a and the second main back pressure pocket 1415b, respectively, with respect to the roller 144. For example, the first sub back pressure pocket 1425a and the second sub back pressure pocket 1425b may be formed to be deeper than the first main back pressure pocket 1415a and the second main back pressure pocket 1415b, respectively.

Although not illustrated in the drawings, the back pressure pockets 1415a, 1415b, 1425a, 1425b may be provided only at any one of the main bearing 141 or the sub bearing 142.

The discharge port 1413 may be formed in the main bearing 141 as described above. However, the discharge port may be formed in the sub bearing 142, formed in each of the main bearing 141 and the sub bearing 142, or formed by penetrating between inner and outer circumferential surfaces of the cylinder 143. This embodiment describes an example in which the discharge ports 1413 are formed in the main bearing 141.

Referring to FIGS. 1 to 3, the cylinder 143 according to this embodiment may be in close contact with a lower surface of the main bearing 141 and be coupled to the main bearing 141 by a bolt, for example, together with the sub bearing 142. Accordingly, the cylinder 143 may be fixedly coupled to the casing 110 by the main bearing 141.

The cylinder 143 may be formed in an annular shape having a hollow space in its center to define the compression space V. The hollow space may be sealed by the main bearing 141 and the sub bearing 142 to define the compression space V, and the roller 144 described hereinafter may be rotatably coupled to the compression space V.

The cylinder 143 may be provided with a suction port 1431 that penetrates from an outer circumferential surface to an inner circumferential surface thereof. However, the suction port may alternatively be formed through the main bearing 141 or the sub bearing 142.

The suction port 1431 may be formed on one or a first side of a contact point P in the circumferential direction. The discharge port 1413 described above may be formed through the main bearing 141 at another or a second side of the contact point P in the circumferential direction which is opposite to the suction port 1431.

An inner circumferential surface 1432 of the cylinder 143 may be formed in an elliptical shape. The inner circumferential surface 1432 of the cylinder 143 according to this embodiment may be formed in an asymmetric elliptical shape in which a plurality of ellipses, for example, four ellipses having different major and minor ratios are combined to have two origins. For example, the inner circumferential surface 1432 of the cylinder 143 according to the embodiment may be defined to have a first origin O which is a center of the roller 144 or a center of rotation of the roller 144 (an axial center or a diameter center of the cylinder) or is biased by a first position from the center toward the contact point P, and a second origin O′ biased from the first origin O toward the contact point P by a second position.

An X-Y plane formed around the first origin O may define a third quadrant Q3 and a fourth quadrant Q4, and an X-Y plane formed around the second origin O′ may define a first quadrant Q1 and a second quadrant Q2. The third quadrant Q3 may be formed by a third ellipse, the fourth quadrant Q4 may be formed by a fourth ellipse, the first quadrant Q1 may be formed by the first ellipse, and the second quadrant Q2 may be formed by the second ellipse.

In addition, the inner circumferential surface 1432 of the cylinder 143 may include a proximal portion 1432a, a remote portion 1432b, and a curved portion 1432c. The proximal portion 1432a is a portion closest to the outer circumferential surface 1441 (or the center of rotation) of the roller 144, the remote portion 1432b is a portion farthest away from the outer circumferential surface 1441 of the roller 144, and the curved portion 1432c is a portion connecting the proximal portion 1432a and the remote portion 1432b.

A point at which the cylinder 143 and the roller 144 are closest to each other on the proximal portion 1432a may also be defined as the contact point P, and the first quadrant Q1 and the fourth quadrant Q4 may be divided based on the proximal portion 1432a. The suction port 1431 may be formed in the first quadrant Q1 and the discharge port 1413 may be formed in the fourth quadrant Q4, based on the proximal portion 1432a. Accordingly, when the vane 1451, 1452, 1453 passes the contact point P, a compression surface of the roller 134 in the rotational direction may receive a suction pressure as a low pressure but an opposite compression rear surface may receive a discharge pressure as a high pressure. Then, while passing the contact point P, the roller 144 may receive a greatest fluctuating pressure between a front surface 1451a, 1452a, 1453a of each vane 1451, 1452, 1453 that comes in contact with the inner circumferential surface of the cylinder 143 and a rear surface 1451b, 1452b, 1453b of each vane 1451, 1452, 1453 that faces the back pressure chamber 1447a, 1447b, 1447c. This may cause tremor of the vane 1451, 1452, 1453 significantly.

Accordingly, in this embodiment, vane springs 1445a, 145b, and 1445c, which will be described hereinafter, may be disposed on the rear surfaces 1451b, 1452b, and 1453b of the vanes 1451, 1452, and 1453, respectively, to suppress or prevent the vanes 1451, 1452, and 1453 from being pushed backwards in the vicinity of the contact point P, thereby preventing tremors of the vanes 1451, 1452, and 1453 around the contact point P in advance. The vane springs 1445a, 145b, and 1445c will be described again hereinafter.

Referring to FIGS. 1 to 3, the roller 144 according to this embodiment may be manufactured separately from the rotary shaft 130 and post-assembled with each other. The roller 144 may be manufactured using a same material as that of the rotary shaft 130, or a material different therefrom. For example, the roller 144 may include a lighter and harder material compared to the rotary shaft 130. In this case, a weight of a o body including the roller 144 may decrease to thereby reduce a load of the drive motor 120.

The roller 144 may be provided as a single body, or an assembly type manufactured such that a plurality of separate parts or components of the roller 144 are manufactured, and then, assembled. In this embodiment, an example in which the roller 144 is provided as a single body is described. However, even when the roller is provided as the assembly type, a basic shape of the roller 144 may be provided using a same method as that for a type of the single body.

The roller 144 according to this embodiment may be rotatably disposed in the compression space V of the cylinder 143, and the plurality of vanes 1451, 1452, 1453 described hereinafter may be inserted in the roller 144 at predetermined intervals along the circumferential direction. Accordingly, the compression space V may be partitioned into as many compression chambers as the number of the plurality of vanes 1451, 1452, and 1453. This embodiment illustrates an example in which there are three vanes 1451, 1452, and 1453, and thus, the compression space V is partitioned into three compression chambers V1, V2, and V3.

An outer circumferential surface of the roller 144 may be provided as a discontinuous surface. For example, the roller 144 may have vane slots 1446a, 1446b, and 1446c, which will be described hereinafter. The vane slots 1346a, 1346b, and 1346c may be open to the outer circumferential surface of the roller body 1341. Accordingly, the outer circumferential surface of the roller 144 may be formed as a discontinuous surface due to open surfaces of the vane slots 1446a, 1446b, and 1446c.

The outer circumferential surface of the roller 144 may be formed in the circular shape as described above, and a rotational center Or of the roller 144 may be coaxially formed with an axial center (no reference numeral given) of the rotary shaft 130. Accordingly, the roller 144 may concentrically rotate together with the rotary shaft 130.

However, as described above, as the inner circumferential surface 1432 of the cylinder 143 may be formed in the asymmetric elliptical shape biased in a specific direction, the rotational center Or of the roller 144 may be biased with respect to an outer diameter center Oc of the cylinder 143. Accordingly, one side of the outer circumferential surface of the roller 144 may be almost brought into contact with the inner circumferential surface 1432 of the cylinder 143, precisely, the proximal portion 1432a, thereby defining the contact point P.

The contact point P may be formed in the proximal portion 1432a as described above. Accordingly, an imaginary line passing through the contact point P may correspond to a minor axis of an elliptical curve defining the inner circumferential surface 1432 of the cylinder 143.

The roller 144 may have the plurality of vane slots 1446a, 1446b, and 1446c, into which the vanes 1451, 1452, and 1453 described hereinafter may be slidably inserted and coupled, respectively. The plurality of vane slots 1446a, 1446b, and 1446c may be provided at preset or predetermined intervals along the circumferential direction. The outer circumferential surface 1341b of the roller 144 may have open surfaces which are open in the radial direction.

The plurality of vane slots 1446a, 1446b, and 1446c may be defined as first vane slot 1446a, second vane slot 1446b, and third vane slot 1446c along a compression-progressing direction (the rotational direction of the roller). The first vane slot 1446a, the second vane slot 1446b, and the third vane slot 1446c may be formed at uniform or non-uniform intervals along the circumferential direction.

For example, each of the vane slots 1446a, 1446b, and 1446c may be inclined by a preset or predetermined angle with respect to the radial direction, so as to secure a sufficient length of each of the vanes 1451, 1452, and 1453. Accordingly, when the inner circumferential surface 1432 of the cylinder 143 is provided in the asymmetric elliptical shape, even when a distance from the outer circumferential surface 1341 b of the roller body 144 to the inner circumferential surface 1432 of the cylinder 143 increases, separation of the vanes 1451, 1452, and 1453 from the vane slots 1446a, 1446b, and 1446c may be suppressed or prevented, which may result in enhancing design freedom for the inner circumferential surface 1432 of the cylinder 143 as well as that of the roller 144.

A direction in which the vane slots 1446a, 1446b, and 1446c are inclined may be a reverse direction to the rotational direction of the roller 144. That is, the front surfaces 1451a, 1452a, and 1453a of the vanes 1451, 1452, and 1453 in contact with the inner circumferential surface 1432 of the cylinder 143 may be tilted toward the rotational direction of the roller 144. This may be advantageous in that a compression start angle may be formed ahead in the rotational direction of the roller 144 so that compression may start quickly.

The back pressure chambers 1447a, 1447b, and 1447c may be formed to communicate with the inner ends of the vane slots 1446a, 1446b, and 1446c, respectively. The back pressure chambers 1447a, 1447b, and 1447c may be spaces in which oil (or refrigerant) at a discharge pressure or intermediate pressure is filled to flow toward the rear sides of the vanes 1451, 1452, and 1453, that is, the rear surfaces 1451b, 1452b, and 1453b of the vanes 1451, 1452, 1453. The vanes 1451, 1452, and 1453 may be pressed toward the inner circumferential surface of the cylinder 143 by the pressure of the oil (or refrigerant) filled in the back pressure chambers 1447a, 1447b, and 1447c. Hereinafter, a direction toward the inner circumferential surface of the cylinder based on a motion direction of the vane may be defined as the front, and an opposite side to the direction may be defined as the rear.

Although not illustrated in the drawings, the plurality of vane slots 1446a, 1446b, and 1446c may be provided in the radial direction, that is, radially with respect to the rotational center Or of the roller 144. Even in this case, the rotation preventing groove 151 may be provided to be located between vane slots, precisely, apart from two neighboring vane slots by a same distance, respectively.

The back pressure chambers 1447a, 1447b, and 1447c may be hermetically sealed by the main bearing 141 and the sub bearing 142, respectively. The back pressure chambers 1447a, 1447b, and 1447c may independently communicate with each of the back pressure pockets 1415a and 1415b, and 1425a and 1425b, and may also communicate with each other through the back pressure pockets 1415a and 1415b, and 1425a and 1425b.

The back pressure pockets 1415a and 1415b, and 1425a and 1425b may be provided to at least partially overlap the rotation preventing unit 150 in the axial direction. Accordingly, a part or portion of oil flowing into the back pressure pockets 1415a and 1415b, and 1425a and 1425b may flow between the rotation preventing groove 151 and the rotation preventing key 152, both included in the rotation preventing unit 150, to effectively provide lubrication between the rotation preventing groove 151 and the rotation preventing key 152.

Referring to FIGS. 1 to 3, a plurality of vanes 1451, 1452, and 1453 according to this embodiment may be slidably inserted into the respective vane slots 1446a, 1446b, and 1446c. Accordingly, the plurality of vanes 1451, 1452, and 1453 may be provided to have substantially a same shape as the respective vane slots 1446a, 1446b, and 1446c.

For example, the plurality of vanes 1451, 1452, 1453 may be defined as first vane 1451, second vane 1452, and third vane 1453 along the rotational direction of the roller 144. The first vane 1451 may be inserted into the first vane slot 1446a, the second vane 1452 into the second vane slot 1446b, and the third vane 1453 into the third vane slot 1446c, respectively.

The plurality of vanes 1451, 1452, and 1453 may have substantially a same shape. For example, the plurality of vanes 1451, 1452, and 1453 may each be formed in a substantially rectangular parallelepiped shape, and front surfaces 1451a, 1452a, and 1453a of the vanes 1451, 1452, and 1453 in contact with the inner circumferential surface 1432 of the cylinder 143 may be provided to have a curved shape in the circumferential direction. Accordingly, the front surfaces 1451a, 1452a, and 1453a of the vanes 1451, 1452, and 1453 may come into line-contact with the inner circumferential surface 1432 of the cylinder 143, thereby reducing friction loss.

In the vane rotary compressor having the hybrid cylinder, when power is applied to the drive motor 120, the rotor 122 of the drive motor 120 and the rotary shaft 130 coupled to the rotor 122 rotate together, causing the roller 144 coupled to the rotary shaft 130 or integrally formed therewith to rotate together with the rotary shaft 130. Then, the plurality of the vanes 1451, 1452, and 1453 may be drawn out of the vane slots 1446a, 1446b, and 1446c by centrifugal force generated by rotation of the roller 144 and the back pressure of the back pressure chambers 1447a, 1447b, and 1447c, which support the rear surfaces 1351b, 1353b, 1353b of the vanes 1451, 1452, and 1453, thereby being brought into contact with the inner circumferential surface 1432 of the cylinder 143.

Then, the compression space V of the cylinder 143 may be partitioned by the plurality of vanes 1451, 1452, and 1453 into as many compression chambers (including suction chamber or discharge chamber) V1, V2, and V3 as the number of the vanes 1451, 1452, and 1453. The compression chambers v1, V2, and V3 may be changed in volume by the shape of the inner circumferential surface 1432 of the cylinder 143 and eccentricity of the roller 144 while moving in response to the rotation of the roller 144. Accordingly, refrigerant suctioned into the respective compression chambers V1, V2, and V3 may be compressed while moving along the roller 144 and the vanes 1451, 1452, and 1453, and discharged into the inner space of the casing 110. Such series of processes may be repeatedly carried out.

As described above, the rotary compressor according to this embodiment performs a type of ‘magnetic centering’ such that the rotary shaft 130 moves together with a rotor in the upward or downward axial direction according to magnetism of a drive motor during operation. In this case, when the roller 144 is provided integrally with the rotary shaft 130 or coupled thereto, both axial side surfaces of the roller 144 are in close contact with a main plate portion of the main bearing 141 or a sub plate portion of the sub bearing 142 facing both axial side surfaces, respectively, thereby causing friction loss or abrasion.

More particularly, when the compressor is started, the rotary shaft 130 ascends along with a rotor, and an upper axial surface 144a (hereinafter, referred to as an upper surface) of the roller 144 is in close contact with the main sliding surface 1411a of the main bearing 141. Thus, an oil film may not be smoothly provided on the upper surface 144a of the roller 144, thereby causing friction loss or abrasion. On the other hand, a clearance may be greatly generated between a lower axial surface 144b (hereinafter, referred to as a lower surface) of the roller 144 and the sub sliding surface 1421a of the sub bearing 142. Thus, leakage between compression chambers may be caused or oil from the sub back pressure pockets 1425a and 1425b may excessively flow into a compression chamber, thereby deteriorating volumetric efficiency.

Thus, in this embodiment, the rotary shaft 130 and the roller 144 are assembled for relative motion, and simultaneously, limit an ascending width of the roller 144 to suppress or prevent friction loss or abrasion between the roller 144 and the main bearing 141 and ensure a sealing clearance between the roller 144 and the sub bearing 142.

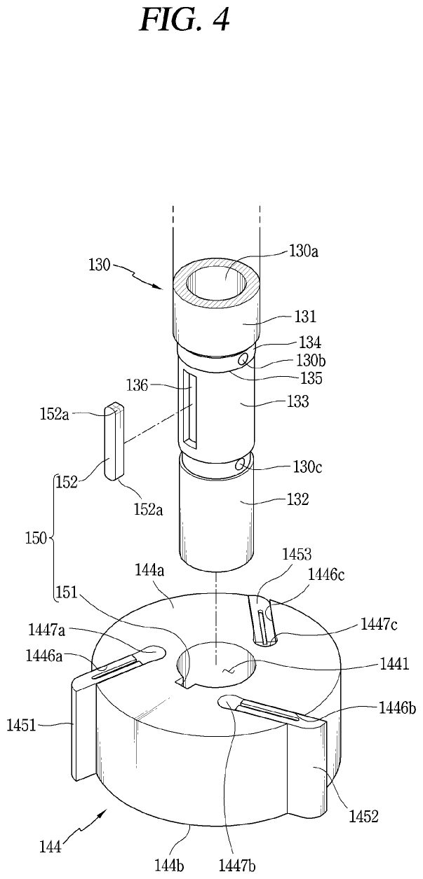

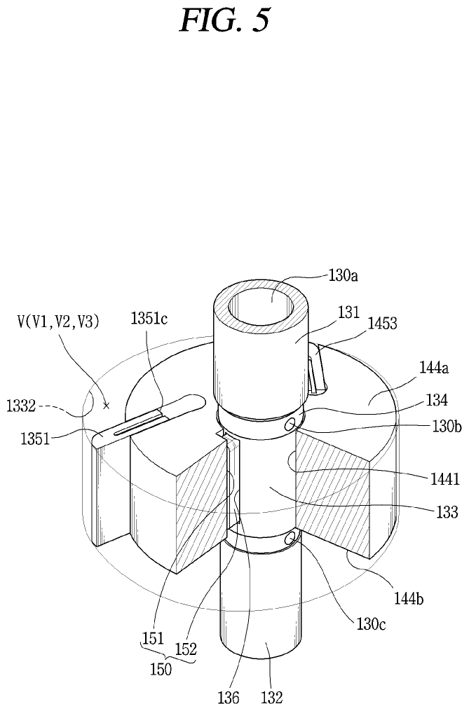

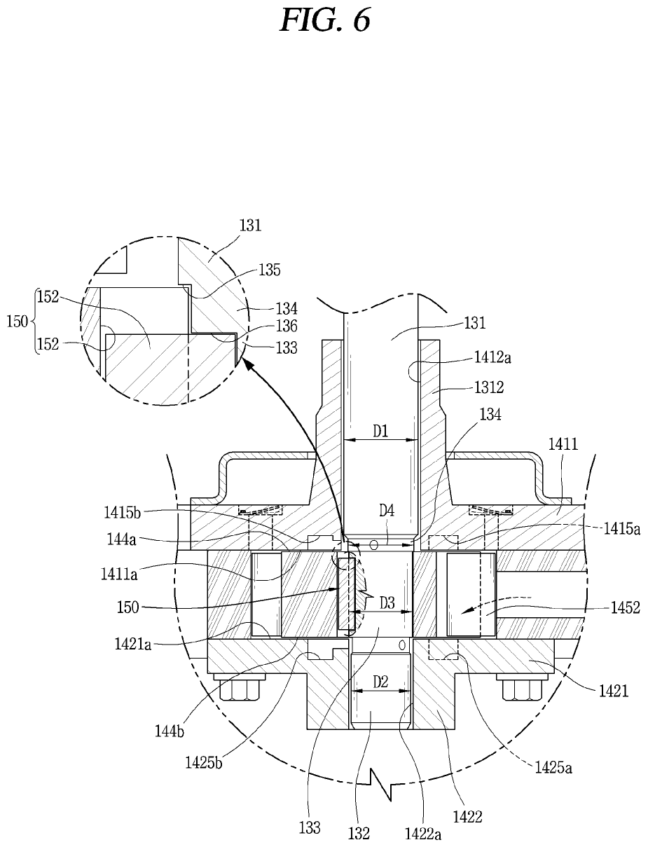

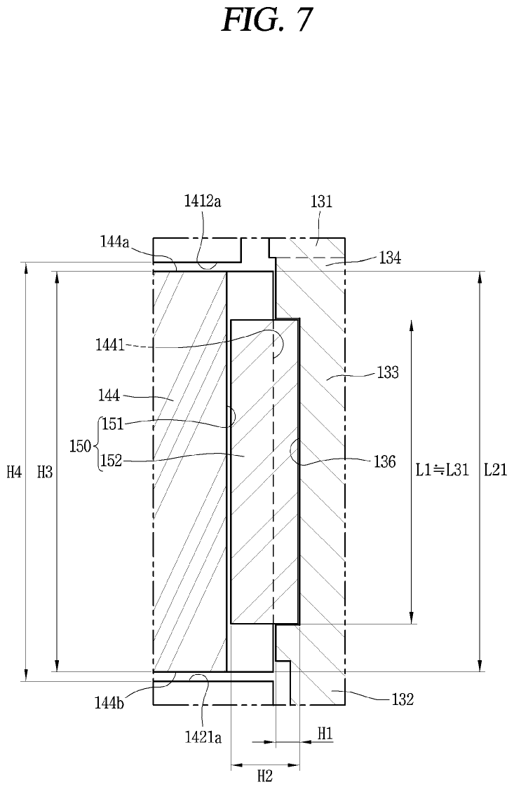

FIG. 4 is an exploded perspective view of the rotary shaft 130 and the roller 144 of FIG. 2. FIG. 5 is an assembled perspective view of the rotary shaft 130 and the roller 144 of FIG. 4. FIG. 6 is a cross-sectional view of FIG. 5. FIG. 7 is an enlarged sectional view of the rotation preventing unit 150 of FIG. 6.

Referring to FIGS. 4 to 7, an outer circumferential surface of the rotary shaft 130 and an inner circumferential surface of the shaft hole 1441, facing the outer circumferential surface of the rotary shaft 130, include the rotation preventing unit 150 configured to prevent rotation of the roller 144 with respect to the rotary shaft 130. Accordingly, even when the rotary shaft 130 and the roller 144 are separately manufactured, and then, post-assembled, a rotational force of the drive motor 120 is transmitted to the roller 144 through the rotary shaft 130, and the roller 144 may rotate with the rotary shaft 130 to compress refrigerant.

However, the rotation preventing unit 150 according to this embodiment constrains the rotary shaft 130 and the roller 144 in the circumferential direction like being nearly coupled to each other, but not in the axial direction so that the rotary shaft 130 and the roller 144 are in a free state. In other words, the rotary shaft 130 and the roller 144 are nearly coupled to each other in the circumferential direction, but slidably coupled to each other in the axial direction.

The rotating preventing unit 150 according to this embodiment may include the rotation preventing groove 151 and the rotation preventing key 152. The rotation preventing groove 151 may be provided in the inner circumferential surface of the roller 144 and the rotation preventing key 152 may be provided on the outer circumferential surface of the rotary shaft 130 to face each other. However, alternatively, the rotation preventing groove 151 may be provided in the outer circumferential surface of the rotary shaft 130 and the rotation preventing key 152 may be provided on the inner circumferential surface of the roller 144.

However, as a roller coupling unit 133 of the rotary shaft 130, which will be described hereinafter, is located between the main bearing unit 131 and the sub bearing unit 132, the former case may have more advantages compared to the latter case in terms of machining. Hereinafter, an example in which the rotation preventing groove 151 is provided in the inner circumferential surface of the roller 144 and the rotation preventing key 152 is provided on the outer circumferential surface of the rotary shaft 130 is described.

Referring to FIGS. 4 and 5, the rotation preventing groove 151 is provided to be radially recessed in the inner circumferential surface of the roller 144. In other words, the shaft hole 1441 may be provided at a center of the roller 144 such that the rotary shaft 130 is inserted into the shaft hole 1441, and the rotation preventing groove 151 described above is provided in the inner circumferential surface of the shaft hole 1441 to be radially recessed to a preset or predetermined depth.

The rotation preventing groove 151 is provided to extend from the upper surface 144a to the lower surface 144b of the roller 144 in the axial direction. Accordingly, the rotation preventing groove 151 may be easily machined, and easily assembled into the rotation preventing key 152.

The rotation preventing groove 151 may be provided to have a same cross-sectional area along the axial direction. Accordingly, the rotation preventing key 152 inserted into the rotation preventing groove 151 may also have a same cross-sectional area along the axial direction so that the roller 144 may smoothly move relative to the rotary shaft 130 in the axial direction.

The rotation preventing groove 151 may be provided to have a shape corresponding to the rotation preventing key 152 described hereinafter. For example, the rotation preventing groove 151 may have a rectangular parallelepiped shape for which an axial length L21 is greater than a circumferential width L22. The rotation preventing groove 151 is provided to have a depth to overlap the rotation preventing key 152 described hereinafter in the circumferential direction. Accordingly, the rotation preventing key 152 described hereinafter may be slidably inserted into the rotation preventing groove 151 in the axial direction and the roller 144 may move relative to the rotary shaft 130 in the axial direction, but circumferential rotation of the roller 144 may be constrained so that the roller 144 may rotate together with the rotary shaft 130.

The roller 144 is inserted into the cylinder 143, and an axial height H3 of the roller 144 may be provided to be slightly less than an axial height H4 of the cylinder 143, the axial height H4 being defined as a space between the main bearing 141 and the sub bearing 142. Accordingly, the upper surface 144a of the roller 144 may be spaced apart from the main sliding surface 1411a of the main bearing 141 and the lower surface 144b of the roller 144 may be spaced apart from the sub sliding surface 1421a of the sub bearing 142 by preset or predetermined clearances, respectively.

In other words, as illustrated in FIG. 7, as the axial height H3 of the roller 144 is provided to be less than the axial height H4 of the cylinder 143, the roller 144 is provided to be movable relative to the cylinder 143 in the axial direction, in a state of being separate from the rotary shaft 130. Accordingly, a first clearance t1 between the upper surface 144a of the roller 144 and the main sliding surface 1411a of the main bearing 141, and a second clearance t2 between the lower surface 144b of the roller 144 and the sub sliding surface 1421a of the sub bearing 142 are generated, and oil flows into the clearances t1 and t2 to provide an oil film. Thus, friction loss and abrasion in the first and second clearances t1 and t2 may be suppressed or prevented.

Referring to FIGS. 4 to 6, the rotation preventing key 152 according to this embodiment protrudes from the outer circumferential surface of the rotary shaft 130 to the inner circumferential surface of the roller 144, in other words, toward the rotation preventing groove 151 included in the inner circumferential surface of the shaft hole 1441 by a preset or predetermined height. The rotation preventing key 152 may extend integrally from the outer circumferential surface of the rotary shaft 130, or be post-assembled on the outer circumferential surface of the rotary shaft 130 to be coupled thereto. In this embodiment, an example in which the rotation preventing key 152 is post-assembled on the outer circumferential surface of the rotary shaft 130 to be coupled thereto is described. Then, an example in which the rotation preventing key 152 extends integrally from the outer circumferential surface of the rotary shaft 130 will be described hereinafter as another embodiment.

Referring to FIGS. 4 and 7, the key accommodating groove 136 is provided in the outer circumferential surface of the rotary shaft 130 such that the rotation preventing key 152 is inserted and coupled into the key accommodating groove 136. The key accommodating groove 136 is provided between the main bearing unit 131 and the sub bearing unit 132, which will be described hereinafter. Accordingly, the rotation preventing key 152 may be slidably inserted in the axial direction into the rotation preventing groove 151 of the roller 144 included in the main bearing unit 131 and the sub bearing unit 132.

In detail, the outer circumferential surface of the rotary shaft 130 includes the main bearing unit 131, the sub bearing unit 132, the roller coupling unit 133, and a roller support unit 134. The main bearing unit 131 is accommodated in main bearing hole 1412a of the main bearing 141, the sub bearing unit 132 is accommodated in a sub bearing hole 1422a of the sub bearing 142, and the roller coupling unit 133 is accommodated in the shaft hole 1441 of the roller 144. The roller support unit 134 is located between the main bearing unit 131 and the roller coupling unit 133. According to a state of the rotary shaft 130, a (first) part or portion of the roller support unit 134 may be accommodated in the main bearing hole 1412a of the main bearing 141, and another (second) part or portion of the roller support unit 134 may be accommodated in the shaft hole 1441 of the roller 144.

An outer diameter D1 of the main bearing unit 131 is provided to be greater than an outer diameter D3 of the roller coupling unit 133. The outer diameter D3 of the roller coupling unit 133 is provided to be greater than an outer diameter D2 of the sub bearing unit 132. Accordingly, the roller 144 may be inserted in a direction from a lower end of the rotary shaft 130, that is, a lower end of the sub bearing unit 132 toward the main bearing unit 131.

In this case, an outer diameter D4 of the roller support unit 134 located between the main bearing unit 131 and the roller coupling unit 133 is less than the outer diameter D1 of the main bearing unit 131 and greater than the outer diameter D3 of the roller coupling unit 133. Accordingly, with reference to a portion between the roller coupling unit 133 and the roller support unit 134, that is, an axial direction center of the roller 144, a roller support surface 135 may be provided to have a height difference at a side adjacent to the drive motor 120.

Referring to FIGS. 4 to 6, the roller support surface 135 may be provided to have an annular shape. For example, the roller support surface 135 may be provided to have an annular shape having a same width along the circumferential direction. Accordingly, the rotary shaft 130 and the roller 144 may be uniformly in contact with each other on the roller support surface 135 along the circumferential direction so that the rotary shaft 130 may be stably supported by the roller 144, or the roller 144 may be stably supported by the rotary shaft 130. However, the roller support surface 135 may be provided along the circumferential direction at a preset or predetermined interval.

The roller support surface 135 may be provided such that the roller 144 is located in a middle portion between the main bearing 141 and the sub bearing 142 in a state when the stator 121 and the rotor 122 are aligned with each other due to magnetic centering. In other words, the roller support surface 135 may be provided in a position at which the first clearance t1 between the roller 144 and the main bearing 141 nearly matches the clearance t2 between the roller 144 and the sub bearing 142 in a state when a center of the stator 121 is arranged with that of the rotor 122.

Accordingly, during operation of the compressor, the roller 144 is located approximately at a center between the main bearing 141 and the main bearing 142. Then, the roller 144 may maintain a state of not being in contact with the main bearing 141 and the sub bearing 142, thus minimizing friction loss or abrasion between the roller 144 and both of the main bearing 144 and the sub bearing 141. When the compressor stops, the roller support surface 135 of the rotary shaft 130 is placed on an upper axial surface of the roller 144 to support the rotary shaft 130 in the axial direction.

The key accommodating groove 136 is provided in an outer circumferential surface of the roller coupling unit 133 such that the rotation preventing key 152 is inserted and fixed into the key accommodating groove 136. Accordingly, the rotary shaft 130 may be easily machined, and the rotation preventing key 152 may be also easily provided on the rotary shaft 130.

The key accommodating groove 136 is provided longitudinally in the axial direction to correspond to the rotation preventing key 152. For example, an axial length L1 of the key accommodating groove 136 according to this embodiment may be equal to or slightly greater than an axial length L21 of the rotation preventing key 152. Accordingly, the rotation preventing key 152 may be easily assembled into the key accommodating groove 136.

The key accommodating groove 136 may be provided to have a constant size along the axial direction. For example, a circumferential width and a radial depth of the key accommodating groove 136 may be provided to be constant along the axial direction. Thus, the key accommodating groove 136 may be easily machined, and assembly stability of the rotation preventing key 152 inserted into the key accommodating groove 136 may be enhanced. By doing so, rotational force may be stably and uniformly transmitted through the rotation preventing key 152.

Referring to FIGS. 4 to 7, the rotation preventing key 152 according to this embodiment is inserted and coupled into the key accommodating groove 136 described above. For example, the rotation preventing key 152 may be press-fit and fixed into the key accommodating groove 136. Although not illustrated in the drawing, the rotation preventing key 152 may be fixedly coupled to the key accommodating groove 136 by an adhesive.

The rotation preventing key 152 may include a same material as that of the rotational shaft 130 or a material having rigidity or hardness similar to that of the rotational shaft 130. Accordingly, the rotation preventing key 152 may transmit the rotational force to the roller 144 without being damaged in a state of being inserted into the key accommodating groove 136.

However, the rotation preventing key 152 may include a material different from that of the rotational shaft 130. For example, the rotation preventing key 152 may include a material having less rigidity or hardness compared to the rotational shaft 130. In this case, the outer circumferential surface of the rotation preventing key 152 may be coated with a material having greater rigidity or hardness compared to the rotation preventing key 152 or a separate sliding member (not shown) may surround the rotation preventing key 152 to be coupled thereto. Accordingly, freedom of material selection for the rotation prevention key 152 may be increased, and rigidity of the rotation prevention key 152 may be also ensured.

The rotation preventing key 152 may have a shape corresponding to the rotation preventing groove 151, for example, a rectangular parallelepiped shape in which an axial length L31 is greater than a circumferential width L32. Accordingly, a circumferential area of the rotation preventing key 152 (or the rotation preventing groove) between the vane slots 1446a, 1446b, and 1446c may be minimized, and the rotational force may also be uniformly transmitted to the roller 144 in the axial direction.

The rotation preventing key 152 may have a size same as or smaller than the rotation preventing groove 151. For example, the axial length L31 of the rotation preventing key 152 may be provided to be equal to or less than the axial length L21 of the rotation preventing groove 151. Accordingly, an axial moving distance of the rotational shaft 130 may be ensured to be greater than that of the roller 144.

The axial length L31 of the rotation preventing key 152 may be equal to or less than the axial length L21 of the rotation preventing groove 151. For example, the axial length L31 of the rotation preventing key 152 may be provided to be about 0.5 times less than the axial length L21 of the rotation preventing groove 151. Accordingly, even when the rotational shaft 130 axially moves toward the stator 121 with the rotor 122 that is magnetic-centered, an upper end of the rotation preventing key 152 may be prevented from coming in contact with the main sliding surface 1411a of the main bearing 141.

Thus, occurrence of friction loss or abrasion in the first clearance t1 between the upper surface 144a of the roller 144 and the main sliding surface 1411a of the main bearing 141 may be suppressed or prevented. In addition, leakage between compression chambers and oil flow into a compression chamber through the second clearance t2 provided between the lower surface 144b of the roller 144 and the sub sliding surface 1421a of the sub bearing 142 may be prevented. Accordingly, compression efficiency may be enhanced.

In addition, the circumferential length L32 of the rotation preventing key 152 may be provided to be less than the circumferential length L22 of the rotation preventing groove 151. Accordingly, the outer circumferential surface of the rotation preventing key 152 may be inserted into the inner circumferential surface of the rotation preventing groove 151 to slide in the axial direction (refer to FIG. 3).

In addition, an axial length H2 of the rotation preventing key 152 may be provided to be about two times or greater than the radial depth H1 of the key accommodating groove 136. Accordingly, when the rotation preventing key 152 is inserted into the rotation preventing groove 151, a part or portion of an outer circumference of the rotation preventing key 152 protrudes, and the protruding part or portion of the outer circumference is inserted into the rotation preventing groove 151 of the roller 141 described hereinafter. Thus, the rotational shaft 130 and the roller 144 may stably constrain each other with respect to the circumferential direction.

As described above, the rotation preventing key 152 may be provided to have a rectangular parallelepiped shape having a great axial length, and a sliding surface 152a may be provided respectively at upper and lower ends of the rotation preventing key 152. For example, an inclined or curve-chambered sliding surface 152a may be provided respectively at circumferential corners of the upper and lower ends of the rotation preventing key 152. Accordingly, abrasion between a lower corner of the rotation preventing key 152 and the sub sliding surface 1412a of the sub bearing 142, facing the lower corner of the rotation preventing key 512, may be suppressed or prevented when the compressor is started in a descending state of the rotational shaft 130, or abrasion between the upper corner of the rotation preventing key 152 and the main sliding surface 1411a of the main bearing 141, facing the upper corner of the rotation preventing key 152, may be suppressed or prevented when the compressor is started in an ascending state of the rotational shaft 130.

Although not illustrated in the drawing, the outer circumferential surface of the rotational shaft 130 and the inner circumferential surface of the roller 144 may be provided to have a D-cut section to match each other. In this case, the separate rotation preventing key 152 and rotation preventing groove 151, described above, may not be provided.

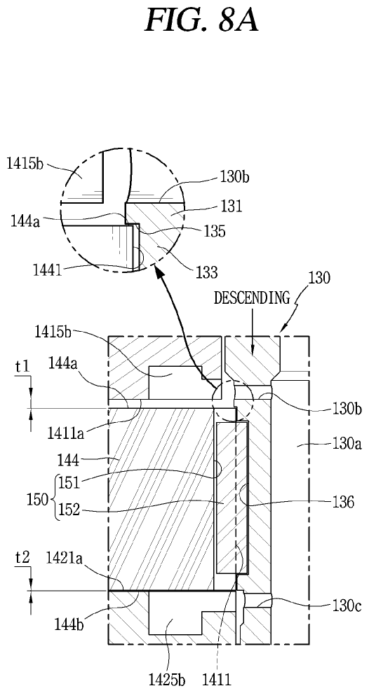

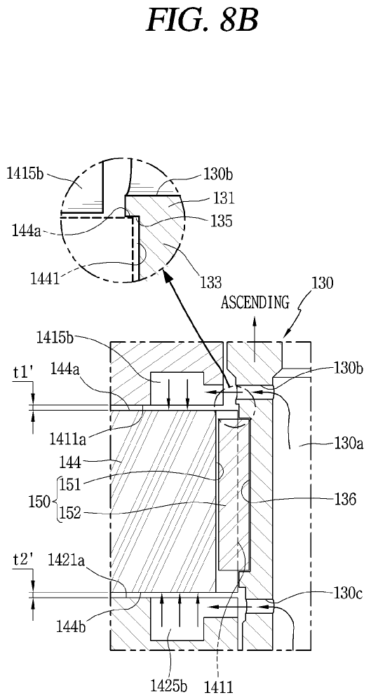

As described above, an effect of the rotary compressor including the rotation preventing unit 150 according to this embodiment is described below. FIG. 8A is a cross-sectional view illustrating a relation between the rotational shaft and the roller in a stopped state of the compressor. FIG. 8B is a cross-sectional view illustrating a relation between the rotational shaft and the roller in an operation state of the compressor. In the drawings, a clearance between the roller and both of the bearings is exaggerated for convenience of description.

Referring to FIG. 8A, when the compressor is in a stopped state, the rotational shaft 130 coupled to the rotor 122 descends due to dead weight. In this case, as the rotation preventing key 152 coupled to the rotational shaft 130 is axially in a free state with respect to the rotation preventing groove 151, the rotational shaft 130 slidably descends in the axial direction relative to the roller 144.

Then, the first clearance t1 between the upper surface 144a of the roller 144 and the main sliding surface 1411a is nearly equal to an axial height difference between the roller 144 and the cylinder 143, and the second clearance t2 between the lower surface 144b of the roller 144 and the sub sliding surface 1421a is nearly 0 (zero). In this case, as a lower end of the rotation preventing key 152 is in contact with the sub sliding surface 1421a of the sub bearing 142, the rotational shaft 130 is axially supported.

Simultaneously, the roller 144 descends separately from the rotational shaft 130 due to dead weight, and thus, the lower surface 144b of the roller 144 is supported by the sub sliding surface 1421a of the sub bearing 142.

Referring to FIG. 8B, when the compressor is in an operation state, the rotor 122 ascends according to magnetic centering so that a center of the rotor 122 and a center of the stator 121 are aligned to have a same height. In this case, as the rotation preventing key 152 is axially in a free state with respect to the rotation preventing groove 151, the rotational shaft 130 slidably ascends in the axial direction relative to the roller 144.

Simultaneously, the roller 144 ascends separately from the rotational shaft 130 according to the pressure of oil filled in the first sub back pressure pocket 1425a and the second sub back pressure pocket 1425b, both included in the sub bearing 142. However, oil is also filled in the first main back pressure pocket 1415a and the second main back pressure pocket 1415b, both included in the main bearing 141, and an ascending amount of the roller 144 is limited by the oil pressure. Accordingly, the roller 144 is spaced apart from the main bearing 141 and the sub bearing 142 due to pressure of the oil filled in the back pressure pockets 1415a and 1415b, and 1425a and 1425b of both of the bearings 141 and 142.

In other words, a first clearance t1′ between the upper surface 144a of the roller 144 and the main sliding surface 1411a is nearly equal to a second clearance t2′ between the lower surface 144b of the roller 144 and the sub sliding surface 1421a. Thus, friction loss or abrasion between the upper surface 144a and the lower surface 144b of the roller 144, and both the main and sub bearings 141 and 142 facing the upper and lower surfaces 144a and 144b may be suppressed or prevented.

Accordingly, rotational force of a rotary shaft is transmitted to a roller, and the roller is also suppressed or prevented from axially moving along the rotary shaft. Thus, friction loss or abrasion between the roller and bearings provided at both axial sides of the roller may be suppressed or prevented. Further, the rotational shaft is axially supported in a stopped state of the compressor, and the roller is spaced apart from a main bearing and a sub bearing in an operation state of the compressor. Thus, friction loss or abrasion between the roller and the main and sub bearings may be effectively suppressed or prevented. In addition, a distance between the roller and the main bearing or between the roller and the sub bearing is constantly maintained. Thus, leakage between compression chambers or oil leakage from a back pressure pocket through a gap between the roller and the bearings may be suppressed or prevented to thereby enhance compression efficiency or volumetric efficiency.

Also, as a rotation preventing key is inserted and post-assembled into a key accommodating groove in the rotational shaft, the rotation preventing key may be easily provided. Also, an assembly structure of the roller and the rotational shaft may be simplified.

Additionally, as the roller rotates with the rotational shaft and the roller is slidably coupled to the rotational shaft, a tolerance between the roller and the rotational shaft may be ensured. Accordingly, after the roller and the rotational shaft are post-assembled, post-machining, such as grinding, may not be performed, and an assembly structure of the roller and the rotational shaft may be simplified.

Hereinafter, a rotation preventing unit according to another embodiment is described. That is, in the embodiment described above, a single-stage rotation preventing key is inserted and coupled into a key accommodating groove. However, a multi-stage rotation preventing key may be inserted and coupled into the key accommodating groove.

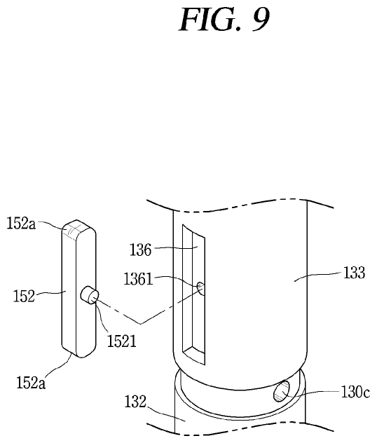

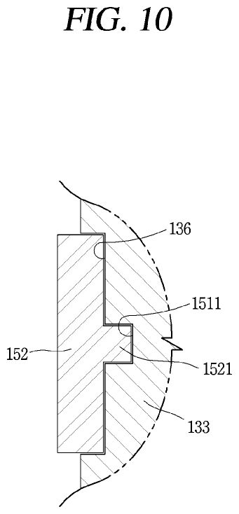

FIG. 9 is an exploded perspective view illustrating the rotation preventing key 152 of FIG. 1 according to another embodiment. FIG. 10 is an assembled cross-sectional view of the embodiment of FIG. 9.

Referring to FIGS. 9 and 10, a basic configuration of the rotation preventing groove 151 and the rotation preventing key 152 both included in the rotation preventing unit 150 according to this embodiment, and an effect resulting therefrom may be nearly identical to those of the embodiment described above. For example, the key accommodating groove 136 may be provided in the rotational shaft 130, and the rotation preventing key 152 may be inserted and coupled into the key accommodating groove 136. The rotation preventing key 152 may be slidably inserted and coupled into the rotation preventing groove 151 in the inner circumferential surface of the roller 144 in the axial direction. Accordingly, the rotation preventing groove 151 and the rotation preventing key 152 may constrain each other in the circumferential direction, and be in a free state within a certain range in the axial direction. With respect to a detailed description thereof, the description about the embodiment described above may be referred to.

However, in this embodiment, the key accommodating groove 136 may be provided in multi-stages, and the rotation preventing key 152 may also be provided in multi-stages to correspond to the key accommodating groove 136. For example, a fixing groove 1511 may be provided at a center of the key accommodating groove 136, and a fixing pin 1521 may be provided on one radial side surface of the rotation preventing key 152, and inserted and coupled into the fixing groove 1511.

The fixing groove 1511 and the fixing pin 1521 may be provided to correspond to each other such that the fixing pin 1521 is inserted into the fixing groove 1511. For example, an inner diameter of the fixing groove 1511 may be provided to be nearly equal to an outer diameter of the fixing pin 1521. Accordingly, the fixing pin 1521 may be press-fit into the fixing groove 1511.

As described above, when the fixing groove 1511 is provided in the key accommodating groove 136 and the fixing pin 1521 is provided on and coupled to the rotation preventing key 152, an area of contact between the key accommodating groove 136 and the rotation preventing key 152 is enlarged, thereby enhancing coupling reliability of the rotation preventing key 152.

In addition, even when an outer circumferential surface of the rotation preventing key 152 is not in close contact with an inner circumferential surface of the key accommodating groove 136, the key preventing key 152 may maintain a state of being inserted into the key accommodating groove 136. By doing so, assembling of the rotation preventing key 152 may be simplified.

Hereinafter, a rotation preventing unit according to still another embodiment is described. That is, in the embodiments described above, a roller and a rotary shaft include a same material. However, the roller and the rotary shaft may be provided to include different materials.

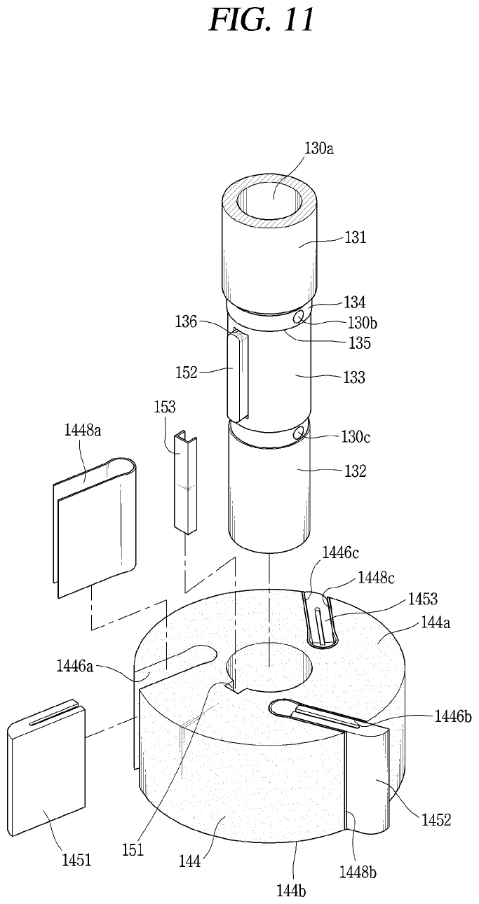

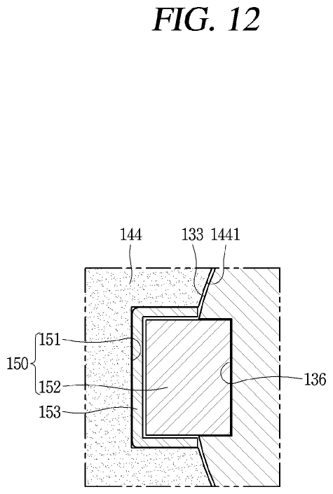

FIG. 11 is an exploded perspective view of the roller of FIG. 1 according to another embodiment. FIG. 12 is a planar view of a rotation preventing unit of FIG. 11.

Referring to FIGS. 11 and 12, a basic configuration of the rotation preventing groove 151 and the rotation preventing key 152 both included in the rotation preventing unit 150 according to this embodiment, and an effect resulting therefrom may be nearly identical to that of the embodiment described above. For example, the key accommodating groove 136 may be provided in the rotary shaft 130, and the rotation preventing key 152 may be inserted and coupled into the key accommodating groove 136. The rotation preventing key 152 may be slidably inserted and coupled into the rotation preventing groove 151 provided in the inner circumferential surface of the roller 144 in the axial direction. Accordingly, the rotation preventing groove 151 and the rotation preventing key 152 may constrain each other in the circumferential direction, and be in a free state within a certain range in the axial direction. As a detailed description thereof, the embodiment described above may be referred to.

However, in this embodiment, the roller 144 and the rotary shaft 130 may be provided to include different materials. In other words, the rotary shaft 130 includes stainless steel, whereas the roller 144 may include a material lighter than that of the rotary shaft 130, that is, a material lighter than stainless steel. Accordingly, by reducing a whole weight of the rotary shaft 130 including the roller 144 by reducing a weight of the roller 144, motor efficiency may be enhanced.

The roller 144 may just need to include a material lighter than the rotary shaft. However, considering that the roller 144 is coupled to the rotation preventing key 152 of the rotary shaft 130, the roller 144 may be provided to include a material with high rigidity as possible to ensure reliability.

A first reinforcing member 153 may be provided between the rotation preventing groove 151 and the rotation preventing key 152. The first reinforcing member 153 may be provided to include a material having higher rigidity or hardness compared to the roller 144. Thus, the roller 144 may include a light material and the rotation preventing groove 151 may be prevented from being crushed. By doing so, a state of coupling between the rotation preventing groove 151 and the rotation preventing key 152 may be stably maintained.

For example, the rotation preventing groove 151 may be provided in the inner circumferential surface of the roller 144 according to this embodiment, and a reinforcing member including a material different from engineering plastic may be inserted into the inner circumferential surface of the rotation preventing groove 151.

The roller 144 may include engineering plastic, and the first reinforcing member 153 may include a material having higher rigidity or hardness compared to engineering plastic. For example, the first reinforcing member 153 may include stainless steel same as that of the rotary shaft 130.

The first reinforcing member 153 is provided to have a same cross-sectional shape as that of an inner circumferential surface of the rotation preventing groove 151 to be press-fit or attached to be coupled thereto. In this case, a step surface (no reference numeral) is provided at a lower end of the rotation preventing groove 151 to axially support a lower end of the first reinforcing member 153.

Although not illustrated, the first reinforcing member (not shown) may be inserted into the outer circumferential surface of the rotation preventing key 152. In this case, the roller 144 may be manufactured using a light material and the rotation preventing groove 151 may be prevented from being crushed to stably maintain a state of coupling between the rotation preventing groove 151 and the rotation preventing key 152.

As described above, as the roller 144 and the rotary shaft 130 is manufactured as separate types, the roller 144 may be manufactured using a material lighter than the rotary shaft 130. By doing so, a weight of the roller 144 may be reduced to decrease a load on a motor, thereby enhancing performance of the compressor.

In this case, the first reinforcing member 153 having high rigidity or hardness may be provided on the outer circumferential surface of the rotation preventing key 152 or the inner circumferential surface of the rotation preventing groove 151. Thus, the roller 144 may include a material lighter than the rotary shaft 130, and a coupling reliability between the roller 144 and the rotary shaft 130 may be ensured.

This may apply to between the roller and vanes. For example, a plurality of the vane slots 1446a, 1446b, and 1446c may be provided in the outer circumferential surface of the roller 144, and second reinforcing members 1448a, 1448b, and 1448c may be press-fit or attached to be coupled to the vane slots 1446a, 1446b, and 1446c. Like the first reinforcing member 153, the second reinforcing members 1448a, 1448b, and 1448c may be provided to include a material having rigidity or hardness higher than the roller 144. Accordingly, the roller 144 may include a material lighter than the rotary shaft 130, and vanes constituting a compression chamber may be stably supported.

Hereinafter, a rotation preventing unit according to still another embodiment is described. That is, in the embodiments described above, a roller support surface is provided on a rotary shaft. However, a hooking surface may be provided on a roller.

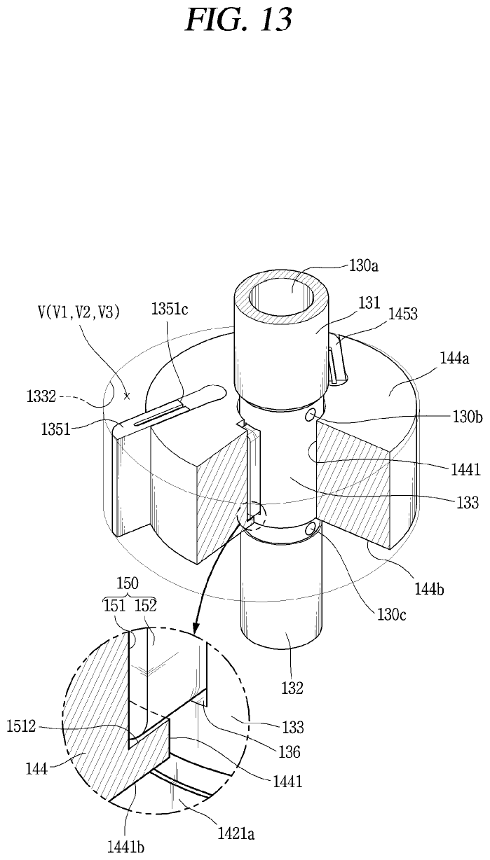

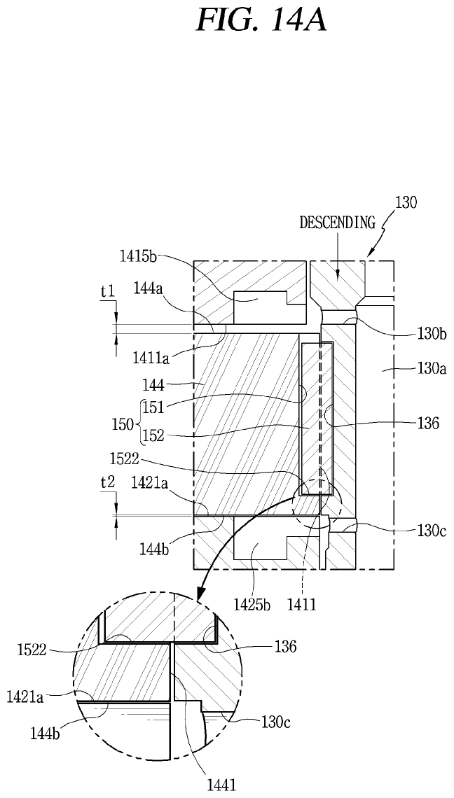

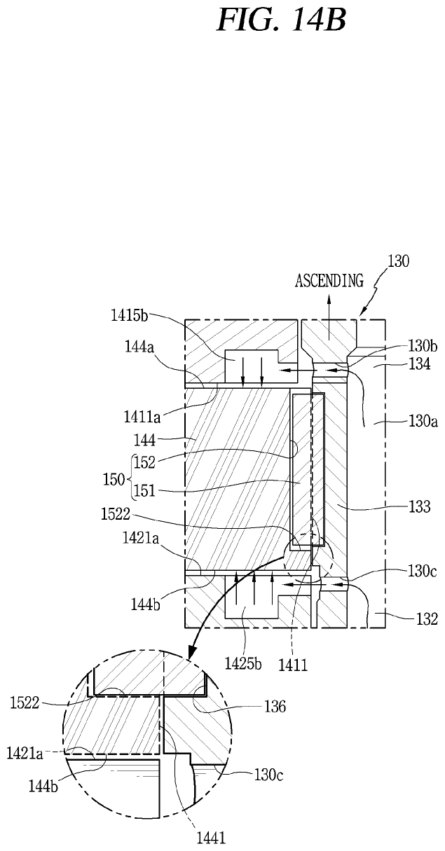

FIG. 13 is a fractured perspective view of the rotation preventing groove of FIG. 1 according to still another embodiment. FIG. 14A is a cross-sectional view illustrating a relation between the rotary shaft and the roller in a stopped state of the compressor of FIG. 13. FIG. 14B is a cross-sectional view illustrating a relation between the rotary shaft and the roller in an operation state of the compressor of FIG. 13.

Referring to FIGS. 13 to 14B, a basic configuration of the rotation preventing groove 151 and the rotation preventing key 152 both included in the rotation preventing unit 150 according to this embodiment, and an effect resulting therefrom may be nearly identical to that of the embodiment described above. For example, the key accommodating groove 136 may be provided in the rotary shaft 130, and the rotation preventing key 152 is inserted and coupled into the key accommodating groove 136. The rotation preventing key 152 is slidably inserted and coupled into the rotation preventing groove 151 in the inner circumferential surface of the roller 144 in the axial direction. Accordingly, the rotation preventing groove 151 and the rotation preventing key 152 may constrain each other in the circumferential direction, and be in a free state within a certain range in the axial direction. With respect to a detailed description thereof, the description about the embodiment described above may be referred to.

However, in this embodiment, a hooking surface 1512 that axially constraints the rotation preventing groove 151 to the rotation preventing key 152 may be provided. For example, an upper end of the rotation preventing groove 151 adjacent to the stator 121 may be open in the axial direction, but a lower end thereof apart from the stator 121 may be closed in the axial direction. Accordingly, in this embodiment, the roller support unit 134 and the roller support surface 135 may not be provided on the outer circumferential surface of the rotary shaft 130. However, the hooking surface 1512 may be provided in the rotation preventing groove 151, and the roller support surface 135 may be provided on the rotary shaft 130 together. In this case, the rotary shaft 130 and the roller 144 may be stably supported.

As described above, when the hooking surface 1512 is provided on the rotation preventing groove 151 to axially support the rotation preventing key 152, a large radially overlapping area between the rotation preventing groove 151 and the rotation preventing key 152 may be ensured. By doing so, the rotary shaft 130 or the roller 144 may be stably supported.

For example, when the compressor is in a stopped state, even when the rotary shaft 130 descends, as illustrated in FIG. 14A, a lower end of the rotation preventing key 152 coupled to the rotary shaft 130 is supported by being placed on the hooking surface 1512 included in the rotation preventing groove 151. Then, the rotary shaft 130 is axially supported to maintain an assembled state.

In addition, when the compressor is in an operation state, even when the roller excessively ascends due to pressure in the sub back pressure pockets 1425a and 1425b, the hooking surface 1512 on the rotation preventing groove 151 of the roller 144 is hooked on a lower end of the rotation preventing key 152 to limit axial movement of the roller 144. Then, excessively close contact between the upper surface 144a of the roller 144 and the main sliding surface 1411a of the main bearing 141 facing the upper surface 144a may be mechanically suppressed or prevented.

Hereinafter, the rotation preventing unit according to yet another embodiment is described. That is, in the embodiments described above, a rotation preventing key is assembled on a rotary shaft. However, the rotation preventing key may be provided integrally on the rotary shaft.

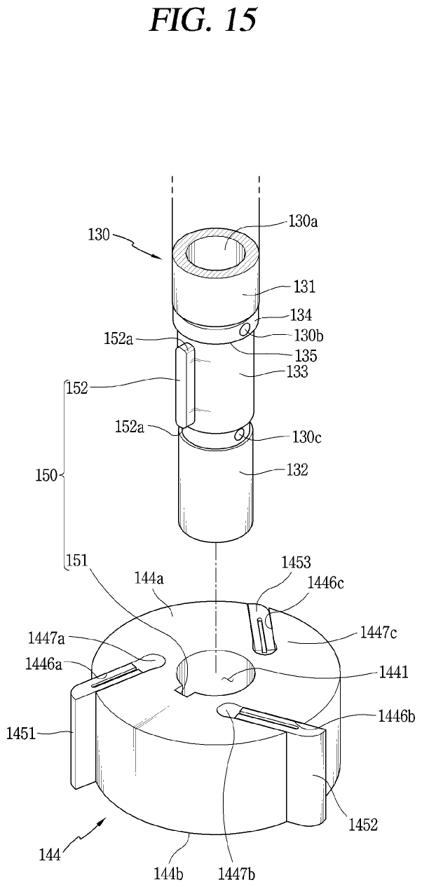

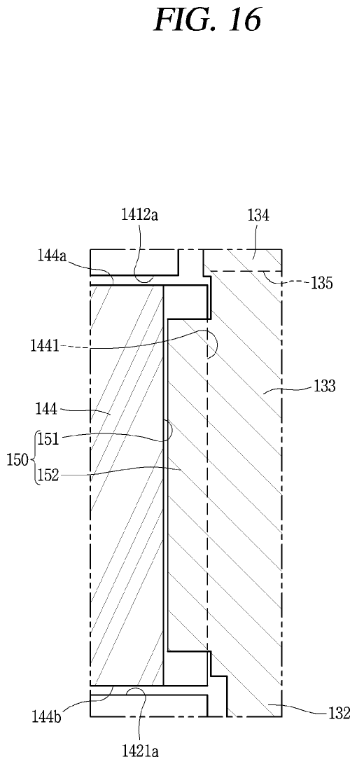

FIG. 15 is a perspective view of the rotation preventing key of FIG. 1 according to yet another embodiment. FIG. 16 is a planar view of FIG. 15.

Referring to FIGS. 15 and 16, a basic configuration of the rotation preventing groove 151 and the rotation preventing key 152 both included in the rotation preventing unit 150 according to this embodiment, and an effect resulting therefrom may be nearly identical to that of the embodiments described above. For example, specifications of the rotation preventing groove 151 and the rotation preventing key 152 are nearly identical to those in the embodiments described above. Thus, with respect to a detailed description thereof, the description about the embodiment described above may be referred to.

However, in this embodiment, the rotation preventing key 152 extend from the outer circumferential surface of the rotary shaft 130 in the radial direction. In other words, the rotation preventing key 152 extends to axially protrude from the roller coupling unit 133 of the rotary shaft 130, and extend longitudinally in the axial direction. Accordingly, the rotation preventing key 152 of the rotary shaft 130 is inserted into the rotation preventing groove 151 of the roller 144 to constrain the circumferential direction between the roller 144 and the rotary shaft 130.

Additionally, in this case, a root portion (no reference numeral) of the rotation preventing key 152 extending from the outer circumferential surface of the rotary shaft 130 may be curved. By doing so, the root portion of the rotation preventing key 152 may be suppressed or prevented from being damaged due to concentration of stress on the root portion.

As described above, when the rotation preventing key 152 is provided integrally with the rotary shaft 130, an effect resulting therefrom is similar to that according to the embodiment described above. In other words, as the rotation preventing key 152 of the rotary shaft 130 is slidably inserted into the rotation preventing groove 151 of the roller 141 in the axial direction, even when the rotary shaft 130 axially moves as described with reference to the above-mentioned embodiments, axial movement of the roller 144 is minimized. Thus, friction loss or abrasion between the roller 144 and both the main and sub bearings 141 and 142 may be minimized.

In addition, like this embodiment, when the rotation preventing key 152 is provided integrally with the rotary shaft 130, a clearance may not occur between the rotary shaft 130 and the rotation preventing key 152 in the circumferential direction. Accordingly, the rotational force of the rotary shaft 130 may be transmitted to the roller 144 simultaneously without delay.

In addition, like this embodiment, when the rotation preventing key 152 is provided integrally with the rotary shaft 130, the rotation preventing key 152 may not need to be assembled into the rotary shaft 130 separately. Thus, working man hours for the rotation preventing unit 1150 including the rotation preventing key 152 and the rotation preventing groove 151 may be reduced.

Although not illustrated, the rotation preventing key 152 and the rotation preventing groove 151 may be provided in a plurality of pairs at uniform intervals along the circumferential direction. In this case, the roller 144 may be firmly coupled to the rotary shaft 130 to stably transmit the rotational force of the rotary shaft 130 to the roller 144.

Although not illustrated, a discharge port may not be provided on the main bearing 141 and the sub bearing 142, but on the cylinder 143. In this case, the rotary shaft 130 described above may be slidably coupled to the roller 144.

Embodiments disclosed herein provide a rotary compressor configured to suppress or prevent friction loss or abrasion between a roller and a bearing axially facing the roller, and also suppress or prevent leakage between compression chambers through a gap between the roller and a sub bearing. Further, embodiments disclosed herein provide a rotary compressor in which the roller is post-assembled with a rotary shaft and the roller is coupled to perform a relative motion with respect to the rotary shaft.

Still further, embodiments disclosed herein provide a rotary compressor in which the roller may perform a relative motion with respect to the rotary shaft and a relative motion range of the roller may be limited. Embodiments disclosed herein provide also provide a rotary compressor in which a roller and a rotary shaft are post-assembled, and an assembly structure of the rotary shaft may be simplified.

Embodiments disclosed herein provide a rotary compressor in which the roller and the rotary shaft are post-assembled, and the roller or the rotary shaft may be easily machined. Still further, embodiments disclosed herein provide a rotary compressor in which a tolerance of the roller and the rotary shaft is ensured so that post-machining after post-assembly may not be performed.

Embodiments disclosed herein provide a rotary compressor such that a weight of the roller may be reduced to increase compression efficiency. Further, embodiments disclosed herein provide a rotary compressor in which the roller and the rotary shaft include different materials to reduce a weight of the roller. Furthermore, embodiments disclosed herein provide a rotary compressor in which the roller and the rotary shaft include different materials, but coupling reliability is enhanced.

Embodiments disclosed herein provide a rotary compressor that may include a casing, a drive motor, a rotary shaft, a main bearing and a sub bearing, a cylinder, a roller, a vane, and a rotation preventing unit. The drive motor may be included inside of the casing. The rotary shaft may be coupled to a rotor in the drive motor and transmit rotational force. The main bearing and the sub bearing may support the rotary shaft. The cylinder may be provided between the main bearing and the sub bearing to provide a compression space. The roller may be provided with a shaft hole through which the rotary shaft penetrates and is inserted in an axial direction. The vane may divide the compression space into a plurality of compression chambers. The rotation preventing unit may be provided between an outer circumferential surface of the rotary shaft and an inner circumferential surface of an axial hole in the roller, the inner circumferential surface facing the outer circumferential surface of the rotary shaft, to constrain rotation of the roller with respect to the rotational shaft. The rotation preventing unit may allow axial movement of the roller with respect to the rotary shaft. Thus, the axial movement of the roller along the rotary shaft may be suppressed or prevented, and friction loss and abrasion between the roller and the main bearing or between the roller or the sub bearing may be suppressed or prevented.

The rotation preventing unit may include a rotation preventing groove and a rotation preventing key. The rotation preventing groove may be provided in an inner circumferential surface of the axial hole. The rotation preventing key may be provided on the outer circumferential surface of the rotational shaft and slidably inserted into the rotation preventing groove in the axial direction. The rotation preventing key may be post-assembled on the rotary shaft. Thus, the rotation preventing key constituting the rotation preventing unit may be easily provided on the rotary shaft.

A key accommodating groove may be provided in the outer circumferential surface of the rotary shaft. The rotation preventing key may be inserted and coupled into the key accommodating groove. Thus, the rotation preventing key may be easily coupled to the rotary shaft, and coupling stability may be also enhanced.

The rotation preventing unit may include a rotation preventing groove and a rotation preventing key. The rotation preventing groove may be provided in an inner circumferential surface of the axial hole. The rotation preventing key may be provided on the outer circumferential surface of the rotary shaft and slidably inserted into the rotation preventing groove in an axial direction. The rotation preventing key may extend integrally from the rotary shaft. Thus, assembly of the rotation preventing unit including the rotation preventing key may be simplified.

The rotation preventing unit may include a rotation preventing groove and a rotation preventing key. The rotation preventing groove may be provided in an inner circumferential surface of the axial hole. The rotation preventing key may be provided on the outer circumferential surface of the rotary shaft and slidably inserted into the rotation preventing groove in an axial direction. An axial length of the rotation preventing key may extend longer than a circumferential width of the rotation preventing key. Thus, a circumferential area of the rotation preventing key may be greatly reduced, and rotational force may be stably transmitted to the roller.

The axial length of the key accommodating key may be provided to be equal to or less than an axial length of the rotation preventing groove. Thus, during axial movement of the rotary shaft, the rotation preventing key may be suppressed or prevented from being hooked on the main bearing or the sub bearing.

The outer circumferential surface of the rotary shaft may be provided with a roller support surface configured to limit axial movement of the roller and have a height difference relative to the outer circumferential surface of the rotary shaft. Thus, the rotary shaft may be axially supported by the roller to enhance assembly stability, and simultaneously, limit axial movement of the roller to suppress or prevent friction loss and abrasion between the roller and a bearing.

The roller support surface may be arranged adjacent to the drive motor with reference to an axial center of the roller. Thus, excessive ascending of the roller toward the main bearing located at an upper side may be suppressed or prevented to reduce friction loss and abrasion between the roller and the main bearing.

The roller support surface may be provided to have an annular shape. Thus, the rotary shaft and the roller may be uniformly supported in t circumferential direction to stably support the rotary shaft or the roller in the axial direction.

The rotation preventing unit may include a rotation preventing groove and a rotation preventing key. The rotation preventing groove may be provided in an inner circumferential surface of the axial hole. The rotation preventing key may be arranged on the outer circumferential surface of the rotary shaft and slidably inserted into the rotation preventing groove in an axial direction. One or a first axial end of the rotation preventing groove may be open and another or a second axial end thereof may be closed to provide a hooking surface to limit axial movement of the rotation preventing key. Thus, the rotational shaft may be axially supported by the roller to enhance assembly stability, and simultaneously, limit axial movement of the roller to suppress or prevent friction loss and abrasion between the roller and a bearing.

The hooking surface may be provided at an end portion far apart from the drive motor with reference to the axial center of the roller. Thus, excessive ascending of the roller toward the main bearing located at an upper side may be suppressed or prevented to reduce friction loss and abrasion between the roller and the main bearing.

The roller may include a material having lower rigidity or hardness compared to the rotational shaft. Thus, a weight of the roller may be reduced, thereby reducing load on the drive motor.

The rotation preventing unit may include a rotation preventing groove and a rotation preventing key. The rotation preventing groove may be provided in an inner circumferential surface of the axial hole. The rotation preventing key may be provided on the outer circumferential surface of the rotary shaft and slidably inserted into the rotation preventing groove in an axial direction. A first reinforcing member may be provided between an inner circumferential surface of the rotation preventing groove and an outer circumferential surface of the rotation preventing key. The first reinforcing member may include a material having higher rigidity or hardness compared to the roller. Thus, the roller may include a material lighter than that of the rotary shaft, and abrasion resistance may be also increased to ensure reliability of the rotation preventing unit.

A vane slot may be provided in an outer circumferential surface of the roller, the vane being inserted into the vane slot, and a second reinforcing member is inserted into the vane slot. The second reinforcing member may include a material having higher rigidity or hardness compared to the roller. Thus, the roller may include a light material, and abrasion resistance between the vane and the vane slot may be also increased to ensure compressor performance.

A back pressure pocket that communicates with the inside of the casing may be on at least one from among a sliding surface of the main bearing or a sliding surface of the sub bearing, the sliding surface of the main bearing facing one or a first axial side surface of the roller and a sliding surface of the sub bearing facing another or a second axial side surface of the roller. Therefore, excessive axial movement of the roller due to pressure of oil in the back pressure pocket may be suppressed or prevented, and thus, friction loss and abrasion between the roller and a bearing facing the roller may be suppressed or prevented.

The back pressure pocket may at least partially overlap the rotation preventing unit in an axial direction. Thus, the oil in the back pressure pocket may flow into the rotation preventing unit to smoothly provide lubrication between the rotation preventing groove and the rotation preventing key both included in the rotation preventing unit.

In the rotary compressor according to embodiments disclosed herein, the inner circumferential surface of the cylinder may be formed in an elliptical shape.

Alternatively, the inner circumferential surface of the cylinder may be formed in a circular shape.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A rotary compressor, comprising:
a casing;
a drive motor provided inside of the casing;
a rotary shaft coupled to a rotor of the drive motor and configured to transmit a rotational force;
a main bearing and a sub bearing that support the rotary shaft;
a cylinder provided between the main bearing and the sub bearing to provide a compression space;
a roller provided with a shaft hole through which the rotary shaft is inserted in an axial direction;
at least one vane that divides the compression space into a plurality of compression chambers; and
a rotation preventing unit provided between an outer circumferential surface of the rotary shaft and an inner circumferential surface of the shaft hole in the roller, the inner circumferential surface facing the outer circumferential surface of the rotary shaft, to constrain rotation of the roller with respect to the rotary shaft, wherein the rotation preventing unit allows axial movement of the roller with respect to the rotary shaft.

2. The rotary compressor of claim 1, wherein the rotation preventing unit comprises:
a rotation preventing groove provided in the inner circumferential surface of the shaft hole; and
a rotation preventing key provided on the outer circumferential surface of the rotary shaft and slidably inserted into the rotation preventing groove in the axial direction, wherein the rotation preventing key is post-assembled on the rotary shaft.

3. The rotary compressor of claim 2, wherein a key accommodating groove is provided in the outer circumferential surface of the rotary shaft, and wherein the rotation preventing key is inserted and coupled into the key accommodating groove.

4. The rotary compressor of claim 1, wherein the rotation preventing unit comprises:
a rotation preventing groove provided in the inner circumferential surface of the shaft hole; and
a rotation preventing key arranged on the outer circumferential surface of the rotary shaft and slidably inserted into the rotation preventing groove in the axial direction, wherein the rotation preventing key extends integrally from the rotary shaft.

5. The rotary compressor of claim 1, wherein the rotation preventing unit comprises:
a rotation preventing groove provided in the inner circumferential surface of the shaft hole; and
a rotation preventing key provided on the outer circumferential surface of the rotary shaft and slidably inserted into the rotation preventing groove in the axial direction, wherein an axial length of the rotation preventing key extends longer than a circumferential width of the rotation preventing key.

6. The rotary compressor of claim 5, wherein the axial length of the rotation preventing key is equal to or less than an axial length of the rotation preventing groove.

7. The rotary compressor of claim 1, wherein the outer circumferential surface of the rotary shaft is provided with a roller support surface configured to limit axial movement of the roller and having a height difference relative to the outer circumferential surface of the rotary shaft.

8. The rotary compressor of claim 7, wherein the roller support surface is arranged adjacent to the drive motor with reference to an axial center of the roller.

9. The rotary compressor of claim 7, wherein the roller support surface has an annular shape.

10. The rotary compressor of claim 1, wherein the rotation preventing unit comprises:
a rotation preventing groove provided in the inner circumferential surface of the shaft hole; and
a rotation preventing key provided on the outer circumferential surface of the rotary shaft and slidably inserted into the rotation preventing groove in the axial direction, wherein a first axial end of the rotation preventing groove is open and a second axial end of the rotation preventing groove is closed to provide a hooking surface to limit axial movement of the rotation preventing key.

11. The rotary compressor of claim 10, wherein the hooking surface is provided at an end portion spaced apart from the drive motor with reference to an axial direction center of the roller.

12. The rotary compressor of claim 1, wherein the roller comprises a material having a lower rigidity or hardness compared to the rotary shaft.

13. The rotary compressor of claim 12, wherein the rotation preventing unit comprises:
a rotation preventing groove provided in the inner circumferential surface of the shaft hole; and
a rotation preventing key provided on the outer circumferential surface of the rotary shaft and slidably inserted into the rotation preventing groove in the axial direction, wherein a first reinforcing member is provided between an inner circumferential surface of the rotation preventing groove and an outer circumferential surface of the rotation preventing key, and the first reinforcing member comprises a material having a higher rigidity or hardness compared to the roller.

14. The rotary compressor of claim 12, wherein at least one vane slot is provided in an outer circumferential surface of the roller, the at least one vane being inserted into the at least one vane slot, and a second reinforcing member is inserted into the at least one vane slot, and the second reinforcing member comprises a material having a higher rigidity or hardness compared to the roller.

15. The rotary compressor of claim 1, wherein a back pressure pocket that communicates with the inside of the casing is provided on at least one of a sliding surface of the main bearing or a sliding surface of the sub bearing, the sliding surface of the main bearing facing a first axial side surface of the roller and a sliding surface of the sub bearing facing a second axial side surface of the roller.

16. The rotary compressor of claim 15, wherein the back pressure pocket at least partially overlaps the rotating preventing unit in the axial direction.

17. A rotary compressor, comprising:
a casing;
a drive motor provided inside of the casing;
a rotary shaft coupled to the drive motor and configured to transmit a rotational force;
a main bearing and a sub bearing that support the rotary shaft;
a cylinder provided between the main bearing and the sub bearing to provide a compression space;
a roller provided with a shaft hole through which the rotary shaft is inserted in an axial direction;
at least one vane that divides the compression space into a plurality of compression chambers; and
a rotation preventing unit including a rotation preventing groove and a rotation preventing key provided between an outer circumferential surface of the rotary shaft and an inner circumferential surface of the shaft hole in the roller, the inner circumferential surface facing the outer circumferential surface of the rotary shaft, to constrain rotation of the roller with respect to the rotary shaft, wherein the rotation preventing unit allows axial movement of the roller with respect to the rotary shaft.

18. The rotary compressor of claim 15, wherein the rotation preventing key is integrally formed with one of the outer circumferential surface of the rotary shaft and the inner circumferential surface of the shaft hole in the roller and the rotation preventing groove is correspondingly formed in the other of the outer circumferential surface of the rotary shaft or the inner circumferential surface of the shaft hole in the roller.

19. The rotary compressor of claim 18, wherein a key accommodating groove is provided into which the rotation preventing key is inserted and coupled.

20. The rotary compressor of claim 17, wherein the outer circumferential surface of the rotary shaft is provided with a roller support surface configured to limit axial movement of the roller and having a height difference relative to the outer circumferential surface of the rotary shaft.
